(19) United States
(12) Patent Application Publication
(10) Pub. No.: US 2012/0124152 A1
(43) Pub. Date: May 17, 2012

(54) SELF-CONFIGURED AND INTUITIVE INTERACTIVE SYSTEM AND METHOD THEREOF

(76) Inventor: Arthur Dai-Sung Kuo, Taipei City (TW)

(21) Appl. No.: 13/296,249

(22) Filed: Nov. 15, 2011

(30) Foreign Application Priority Data
Nov. 15, 2010 (TW) 099139168

(51) Int. Cl. G06F 15/16

(52) U.S. Cl. 709/206

(57) ABSTRACT

A self-configured and intuitive interactive device and system, featuring an automated method for accessing networked services, characterized by turning on an interactive device, inputting a mobile phone number and/or an e-mail address of a person intended for interacting with, sending an interactive notification request message to the intended person, the intended person utilizing a client device to log in to a server and/or replying to the interactive request message to record personal and networked service account information, and the server forwarding the recorded information to the interactive device, and configures access to the relevant networked services for the interactive device. The interactive device utilizing the received information to access relevant networked services and begin interaction with the intended person.

### BACKGROUND OF THE INVENTION

1. Field of the Invention

The present invention relates to interactive systems and methods, and particularly to a self-configured, intuitive interactive system that avoids complicated configurations, and related method.

2. Description of the Prior Art

Current communications devices provide a plethora of smart services, including voice, video, text, photo image, and network functions, bringing interpersonal interactions and relationships closer together. However, those who know only to dial telephone numbers, and are unfamiliar with computers and smart electronic devices, as well as the elderly, who most need to interact with others, face a large technical gap that is difficult to overcome when using such services.

Complicated user configuration in high-tech products form part of the difficulty facing such users when trying to use the various modern day smart interactive network service applications. Those who are unfamiliar with computers and smart electronic products are therefore unable to enjoy the convenience made available by many current communication applications and interactive network services.

### SUMMARY OF THE INVENTION

According to an embodiment, a method of performing interaction comprises turning on an interactive device, inputting a mobile phone number or email address of an intended person for interacting with, sending an interactive notification message to a server containing the mobile phone number or email address, the server sending an interactive request message to a client device of the intended person according to the interactive notification message using the mobile phone number or email address, the intended person using the client device to log in to the server to record interactive network service account information and/or respond to the interactive request message according to the content of the interactive request message, the server sending the recorded information and/or a response complete message to the interactive device, and the interactive device beginning interaction with the intended person according to the received interactive service account information of the response complete message.

According to another embodiment, a method of performing interaction comprises turning on an interactive device, inputting a mobile phone number or email address of an intended person for interacting with, sending an interactive notification message to a server containing the mobile phone number or email address, the server sending an interactive request message to a client device of the intended person according to the interactive notification message using the mobile phone number or email address, the intended person using the client device to log in to the server to record interactive network service account information and/or respond to the interactive request message according to the content of the interactive request message, the server sending the recorded information and/or a response complete message to the interactive device, the server registering an interactive network service user account on behalf of the interactive device user, the server sending registered account information to the interactive device, the interactive device sending add-request to the intended person, and the interactive device adding the intended person to the interactive network service account user's group of connected users list.

According to another embodiment, a method of performing self-configuration intuitively comprises turning on an interactive device, inputting a mobile phone number or email address of an intended person for interacting with, sending an interactive notification message to a client device of the intended person according to the mobile phone number or email address, the intended person using the client device to log in to a server to record personal interactive network service account information and/or respond to the interactive notification message according to the content of the interactive notification message, the server sending the recorded information and/or response complete message to the interactive device, the server registering an interactive service user account on behalf of the interactive device user, the interactive device sending add-request to the intended person, and the interactive device adding the intended person to the interactive network service account user's group of connected users list.

According to an embodiment, a self-configuring, intuitive interactive system comprises an interactive device, a server, and a client device. The interactive device is used for inputting a mobile phone number or email address of an intended person, and sending an interactive notification message, sending an interactive request message, sending an add request message, and adding an interactive network service account of an intended person. The server is used for receiving the interactive notification message, sending an interactive request message according to the interactive notification message on behalf of the interactive device, registering a user interactive network service account corresponding to the interactive network service, allowing an intended person to log in and record and/or respond and record an interactive network service account information, and sending the recorded service account information of the intended person, and/or response complete message to the interactive device. The client device is used for receiving the interactive request message, connecting to the server, connecting to the interactive network service, and receiving the add request message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a self-configuring, intuitive interactive system according to an embodiment.

FIG. 2 is a flowchart of an interactive method for performing self-configuration intuitively according to another embodiment.

FIG. 3 is a flowchart of an interactive method for performing self-configuration intuitively according to another embodiment.

FIG. 4 is a flowchart of an interactive method for performing self-configuration intuitively according to another embodiment.

FIG. 5 is a flowchart of an interactive method for performing self-configuration intuitively according to another embodiment.

### DETAILED DESCRIPTION

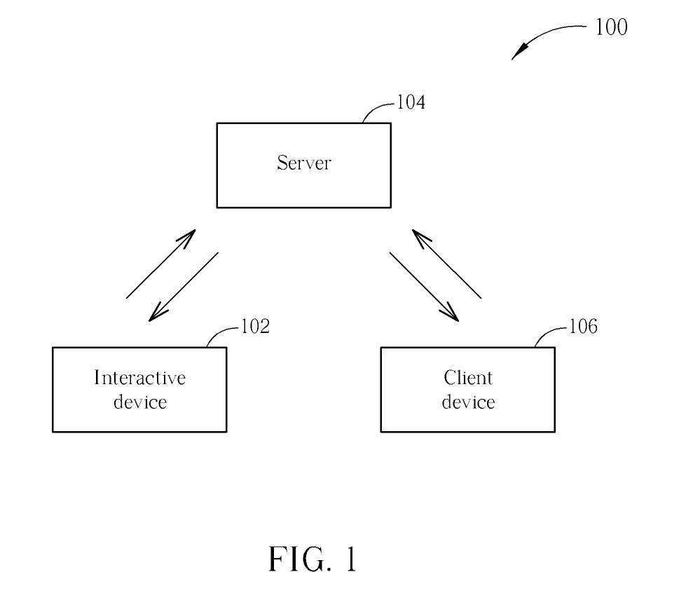

Please refer to FIG. 1, which is a diagram of a self-configuring, intuitive interactive system 100 according to an embodiment. The interactive system 100 comprises an interactive device 102, a server 104, and a client device 106. The interactive device 102 is utilized for inputting a mobile phone number or electronic mail address, sending an interactive request message and sending an add request message according to the mobile phone number or electronic mail address. The interactive device 102 may be a smart phone, a computer or tablet computer, a personal digital assistant, or other smart communications device. The server 104 is utilized for registering a user interactive network service account corresponding to an interactive network service, receiving an interactive notification message, sending an interactive request message according to the interactive notification message, and sending personal and interactive network service information recorded by an intended person to the interactive device 102. The client device 106 is utilized for receiving the interactive request message, connecting to the server 104, connecting to the interactive network service, and receiving the add request message. The client device 106 may be a smart phone, a computer or a tablet computer, a personal digital assistant, or other smart communications device. The interactive device 102 and the client device 106 may connect to the server 104 through a wired connection or a wireless connection. The wireless connection may be through a Wireless Local Area Network (WLAN) or Personal Area Network (PAN), e.g. an IEEE 802.15.4 (Zigbee) short distance wireless transmission standard network, Bluetooth connection, or Wireless Wide Area Network (WWAN).

When a user of the interactive device 102 obtains the interactive device 102, a communications service provider stores basic personal information (name, phone number, birthday, email address, personal identification number) provided by the user on the server 104. The server 104 acts as a proxy to register a user interactive network service account corresponding to an interactive network service according to the basic information of the user of the interactive device 102. The user may also input his/her basic personal information on the interactive device, and send the personal information to the server 104. The server 104 may then act as a proxy to register a user interactive network service account corresponding to an interactive network service according to the basic information of the user of the interactive device 102.

The user of the interactive device 102 may utilize a touch panel, a keyboard, and/or a voice control input interface of the interactive device 102 to input a mobile phone number or email address of an intended person for interacting with. The interactive device 102 sends an interactive notification message to the server 104 containing the mobile phone number or email address inputted by the user. The server 104 sends an interactive request message to the client device 106. The interactive request message comprises web address of the server 104, and a password or request response message used for logging in to the server 104. According to the interactive request message, the intended person uses the client device 106 to log in to the server 104 and/or respond to the interactive request message. The intended person using the client device 106 utilizes the web address and password to log in to the server 104 or reply to the request response message to the server. After the intended person logs in to the server 104, he/she records the interactive network service account information belonging to the intended person or the personal website address belonging to the intended person on the server 104. The intended person can also respond to the interactive request message and record the interactive network service account information on the server without logging into the server. Responding to the interactive request message may include sending the interactive network service account information belonging to the intended person or the personal website address belonging to the intended person to the server 104. After the intended person records the interactive network service account information belonging to the intended person or the personal website address belonging to the intended person to the server 104, or sends the interactive network service account information belonging to the intended person or the personal website address belonging to the intended person in response to the interactive request message to the server 104, the server 104 sends the interactive network service account information or the personal website address belonging to the intended person recorded by the intended person to the interactive device 102. If the interactive device user 102 does not have a user interactive network service account needed for the desired interaction, the server 104 registers a user interactive network service account for the corresponding interactive network service on the user's behalf according to the basic information of the user of the interactive device 102. After the interactive device 102 receives the intended person's interactive network service account information from the server 104, for interactive network services that do not require permission to add an intended person, the intended person's interactive network service account is added, and access to interactive content is obtained. For interactive network services that require permission to add an intended person, an add request message is sent to the interactive network service account belonging to the intended person on the corresponding interactive network service account. The add request message comprises the interactive network service account belonging to the user of the interactive device 102 on the desired interactive network service. The intended person uses the client device 106 to add the user of the interactive device 102 to a group of connected users on the intended person's interactive network service account and access to interactive content is obtained.

Acquirement of interactive network services and an interactive linking process occurring between the interactive device 102 and the client device 106 as described above do not require any configuration by the user of the interactive device 102. The only requirement is that the intended person record the intended interactive network service account or intended interactive website address to the server 104, or respond with the intended interactive network service account or intended interactive website address to server 104, then add the interactive network service account belonging to the user of the interactive device 102 to a group of connected users on the intended person's interactive network service account corresponding to the interactive network service. The user of the interactive device 102 may repeat the process described above at any time to access interactive network service content with other intended people.

After the interactive device 102 completes the above interactive linking establishment, the user of the interactive device 102 may use the following methods to interact with the intended person.

The user of the interactive device 102 may select to access interactive network service content with an intended person including voice, video, text, photo, social networking, remote health and other personalized interactive network services.

The user of the interactive device 102 may select a multimedia interactive function and an intended person, choosing to dial a voice or video call, or send a multimedia file to the intended person. Selecting to make a voice or video call directly dials a phone number of the client device 106, a video and/or voice service such as a Skype account, or an Instant Messaging network service account belonging to the intended person, so that the user of the interactive device 102 can converse with the intended person through the interactive device 102. Sending a multimedia file to the intended person may include the interactive device 102 recording a multimedia voice or video message file of the interactive device user, and uploading the multimedia file to the interactive network service account of the intended person through the above described wired or wireless connection, or uploading the multimedia file to the server 104 or another server, and sending a notification message to the client device 106 or to an email address belonging to the intended person for initiating download. The client device 106 may also utilize the server 104 to send a multimedia file to the interactive device 102 or another server, or may directly send the multimedia file to the email address of the user of interactive device 102 for obtaining the multimedia file through the interactive device 102.

The user of the interactive device 102 may select a text interactive function and an intended person. The user of the interactive device 102 may utilize a voice control interface to convert a voice signal to a text message, utilize a touch panel to input the text message through writing, and/or utilize a keyboard to type the text message. The interactive device 102 directly uploads the text message inputted by the user to the interactive network service account of the intended person through the above described wired or wireless connection. The interactive device 102 may send Short Message Service (SMS) text messages, Instant Messages (IM) and/or emails to the client device 106 used by the intended person. The intended person may also use the client device 106 to send any form of text message, SMS messages, IM, and/or emails to the user of interactive device 102, all of which may be integrated and received by the interactive device 102.

The user of the interactive device 102 may select a photo interactive function and an intended person. The interactive device 102 directly uploads a photo selected by the user to the interactive network service account(s) of the user and/or the intended person through the above described wired or wireless network. After the user selects the intended person, the user may choose to browse photos of the interactive network service account belonging to the intended person online, or to download the photos of the interactive network service account belonging to the intended person periodically or in real-time. The user of interactive device 102 may send a texted photo message to the interactive network service account of the intended person through the above-mentioned text message interactive function provided by the interactive network service account. The user of the interactive device 102 may plug a digital camera memory card directly into the interactive device 102, and browse content thereof and/or utilize an internal camera module of the interactive device 102 to take a photo to browse. The user may select a photo to upload to the interactive device user's interactive network service account and/or the interactive network service account of the intended person, or use another service (such as email, MMS or IM) to send the photo to the client device 106 of the intended person.

The user of the interactive device 102 may select an activity status viewing function and the intended person. The interactive device 102 uses the abovementioned wired or wireless connection to connect to the interactive network service such as a social networking account of the intended person, and display all activity status messages available for browsing. Or, the user may choose to let the interactive device 102 download activity status messages of the intended person on the interactive network service account periodically and/or in real time. The user may use the above-mentioned text messaging interactive function to send a comment or reply message to the interactive network service account belonging to the intended person according to the activity status messaging function on the interactive network service used by the intended person. Likewise, the interactive device user may use the abovementioned text messaging interactive function to send activity status messages to the interactive network service account belonging to the user of device 102 for the intended person to browse.

The interactive device 102 may also be a remote health services hub. Thus, the user of the interactive device 102 may use the wired or wireless communications interface of the interactive device 102 to connect to an online health service to send blood pressure records, blood sugar records, and other such health measurement device measurement information and messages to the online health service. The online health service may provide the user of the interactive device 102 with remote health service according to health measurement information uploaded by the user. Simultaneously, the user of the client device 106 may also utilize the server 104 or another server to obtain the online health service content of the user of the interactive device 102 for further interpersonal interaction.

The interactive device 102 may also be a smart home hub. Thus, the user of the interactive device 102 may use the wired or wireless communications interface of the interactive device 102 to connect to other third-party smart home devices, and utilize the interactive device 102 to control and manage the third-party smart home devices connected thereto. Simultaneously, the user of the client device 106 may also utilize the server 104 or another server to control and manage the third-party smart home devices that the interactive device 102 is connected to.

The server 104 may also automatically download regional service content for the interactive device 102 either periodically and/or in real time according to the position of the interactive device. Positioning information may be obtained through an IP address or communications system positioning service, such as a mobile based cellular network positioning service or Global Positioning Service (GPS).

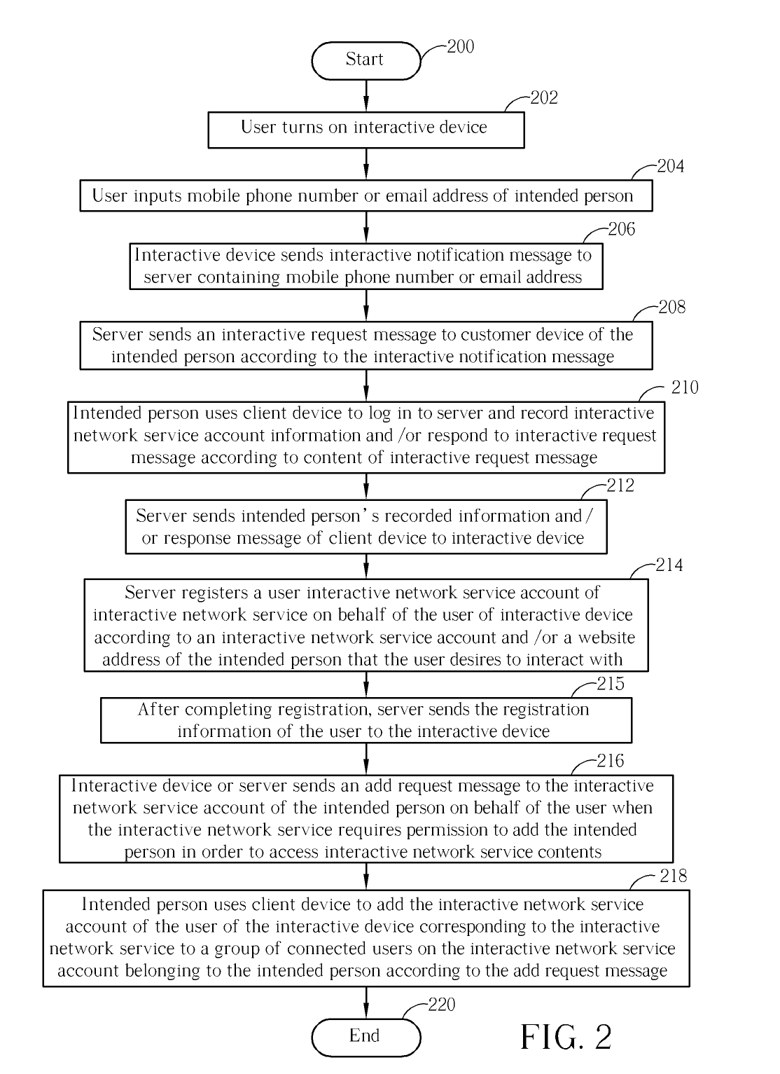

Please refer to FIG. 2, which is a flowchart of an interactive method for performing automated service configuration intuitively according to another embodiment. The method of FIG. 2 is described with reference to the interactive system 100 of FIG. 1, and includes the following steps:

Step 200: Start;

Step 202: The user turns on the interactive device 102;

Step 204: The user inputs the mobile phone number or email address of the intended person;

Step 206: The interactive device 102 sends an interactive notification message to the server 104 containing the mobile phone number or the email address;

Step 208: The server 104 sends an interactive request message to the client device 106 of the intended person according to the interactive notification message;

Step 210: The intended person uses the client device 106 to log into the server 104 and record interactive network service account information and/or respond to the interactive request message according to the content of the interactive request message;

Step 212: The server 104 sends the intended person's recorded information and/or the response message of the client device 106 to the interactive device 102;

Step 214: The server 104 registers a user interactive network service account of an interactive network service on behalf of the user of the interactive device 102 according to the interactive network service account and/or a website address of the intended person that the user desires to interact with;

Step 215: After completing registration, the server 104 sends the registration information of the user to the interactive device 102;

Step 216: The interactive device 102 or the server 104 sends an add request message to the interactive network service account of the intended person on behalf of the user when the interactive network service requires permission to add the intended person in order to access interactive network service contents;

Step 218: The intended person uses the client device 106 to add the interactive network service account of the user of the interactive device 102 corresponding to the interactive network service to a group of connected users on the interactive network service account belonging to the intended person according to the add request message;

Step 220: End.

In step 210, the interactive request message comprises the web address of the server 104 and a password used for logging into the server 104 and/or a response request message. Thus, according to the web address of the server 104 and the password for logging into the server 104, the intended person using the client device 106 may log into the server 104 and record the interactive network service account desired for interaction and/or the web address of an interactive website to the server 104, and/or may use the response request message to respond with the interactive network service account desired for interaction and/or the web address of the interactive website to the server 104. The server 104 registers a user interactive network service account corresponding to the interactive network service desired for interaction on behalf of the user according to the basic information of the user of the interactive device 102. In step 216, for interactive network services that require permission from the intended person to add the user of device 102, such as social networks, Skype, and Instant Messaging services, the interactive device 102 or the server 104 sends an add request message to the interactive network service account of the intended person. The add request message comprises the user's interactive network service account belonging to the user of the interactive device 102. Thus, in step 218, the intended person adds the user's interactive network service account to a group of connected users on the interactive network service account belonging to the intended person corresponding to the interactive network service desired for interaction.

In another embodiment of the method shown in FIG. 2, when the user of the interactive device 102 has already applied for a network access service at a communications service provider, the service provider may already possess the personal information of the user, and may log into the server 104 to configure accounts access to interactive network services (e.g. a social network, online photo album, web blog, Skype, MSN, etc.) on behalf of the user. Or, the user may not go through the communication service provider (or other service providers) to pre-register the user interactive network service accounts, but may use the interactive device 102 to enter his/her personal information, and upload the personal information to the server 104, allowing the server 104 to configure the user's interactive network service accounts on behalf of the user. Thus, step 214 is optional, and may be removed from the method shown in FIG. 2.

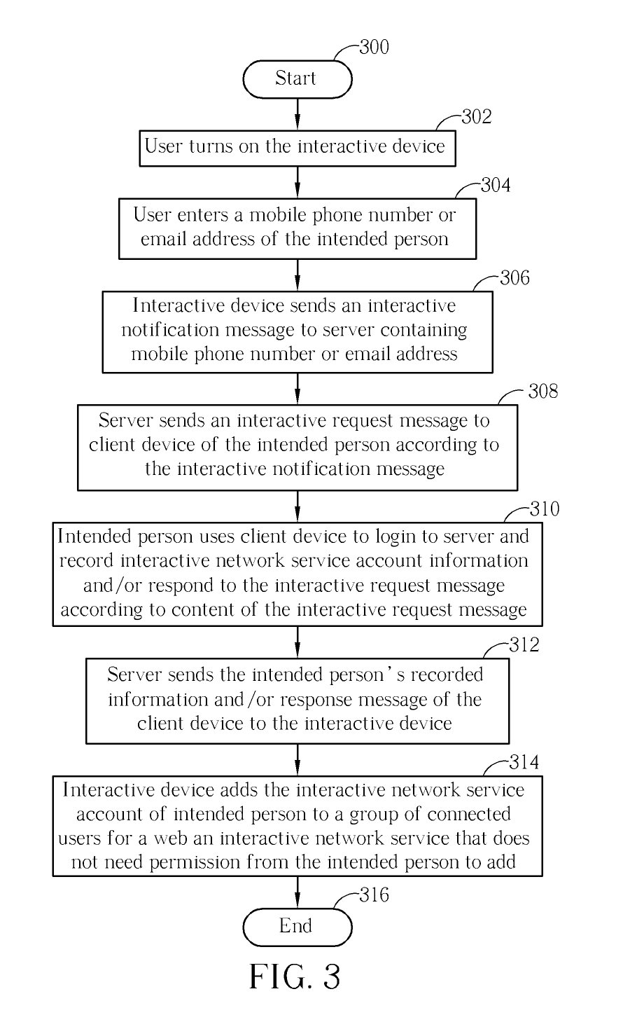

Please refer to FIG. 3, which is a flowchart of an interactive method for performing automated service configuration intuitively according to another embodiment. The method of FIG. 3 is described with reference to the interactive system 100 of FIG. 1, and includes the following steps:

Step 300: Start;

Step 302: The user turns on the interactive device 102;

Step 304: The user enters a mobile phone number or email address of the intended person;

Step 306: The interactive device 102 sends an interactive notification message to the server 104 containing the mobile phone number or email address;

Step 308: The server 104 sends an interactive request message to the client device 106 of the intended person according to the interactive notification message;

Step 310: The intended person uses the client device 106 to login to the server 104 and record interactive network service account information and/or respond to the interactive request message according to the content of the interactive request message;

Step 312: The server 104 sends the intended person's recorded information and/or the response message of the client device 106 to the interactive device 102;

Step 314: The interactive device 102 adds the interactive network service account of the intended person to a group of connected users for an interactive network service that does not need permission from the intended person to add;

Step 316: End.

The embodiment of FIG. 3 differs from the embodiment of FIG. 2 in that the embodiment of FIG. 3 is used for adding interactive network service accounts that do not require permission to add from the intended person, such as web blogs, online photo albums, and other such public personal websites and interactive network services. Thus, the embodiment of FIG. 3 does not require steps 214-218. Principles of operation of the rest of the embodiment shown in FIG. 3 are the same as those of the embodiment of FIG. 2.

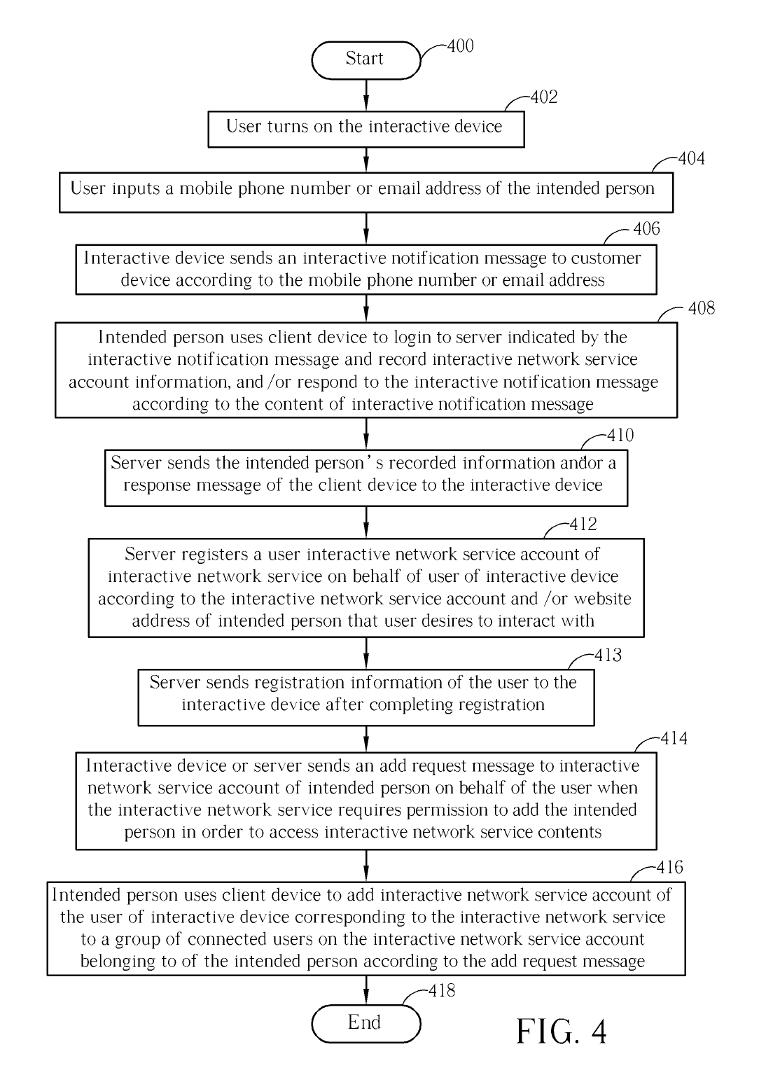

Please refer to FIG. 4, which is a flowchart illustrating an interactive method for performing automated service configuration intuitively according to another embodiment. The method of FIG. 4 is described with reference to the interactive system 100 of FIG. 1, and includes the following steps:

Step 400: Start;

Step 402: The user turns on the interactive device 102;

Step 404: The user inputs a mobile phone number or email address of the intended person;

Step 406: The interactive device 102 sends an interactive notification message to the client device 106 according to the mobile phone number or email address;

Step 408: The intended person uses the client device 106 to login to a server 104 indicated by the interactive notification message and record interactive network service account information, and/or respond to the interactive notification message according to the content of the interactive notification message;

Step 410: The server 104 sends the intended person's recorded information and/or the response message of the client device 106 to the interactive device 102;

Step 412: The server 104 registers a user interactive network service account of an interactive network service on behalf of the user of the interactive device 102 according to the interactive network service account and/or a website address of the intended person that the user desires to interact with;

Step 413: After completing registration, the server 104 sends the registration information of the user to the interactive device 102;

Step 414: The interactive device 102 or the server 104 sends an add request message to the interactive network service account of the intended person on behalf of the user when the interactive network service requires permission to add the intended person in order to access interactive network service contents;

Step 416: The intended person uses the client device 106 to add the interactive network service account of the user of the interactive device 102 corresponding to the interactive network service to a group of connected users on the interactive network service account belonging to the intended person according to the add request message;

Step 418: End.

The embodiment of FIG. 4 differs from the embodiment of FIG. 2 in that, in the embodiment of FIG. 4, the interactive notification message sent by the interactive device 102 to the intended person comprises a web address of the server 104 and a password used for logging into the server 104 and/or a response request message. Thus, in step 408, according to the web address of the server 104 and the password used for logging into the server 104, the intended person using the client device 106 may log in to the server 104 indicated by the interactive notification message, and record an interactive network service account desired for interaction and/or a web address of a website desired for interaction on the server 104, and/or use the response request message to respond and record the interactive network service account desired for interaction and/or the web address of the website desired for interaction to the server 104. Principles of operation of the rest of the embodiment shown in FIG. 4 are the same as those of the embodiment of FIG. 2.

In another embodiment of FIG. 4, when the user of the interactive device 102 has already applied for a network access service at a communication service provider, the communication services provider may already possess the personal information of the user, and may log into the server 104 to configure accounts access to interactive network services (e.g. a social network, online photo album, web blog, Skype, MSN, etc.) on behalf of the user. Or, the user may not go through the communications service provider (or other service providers) to pre-register the user interactive network service accounts, but may use the interactive device 102 to enter his/her personal information, and upload the personal information to the server 104, allowing the server 104 to configure the user's interactive network service accounts on behalf of the user. Thus, step 412 is optional, and may be removed from the method shown in FIG. 4.

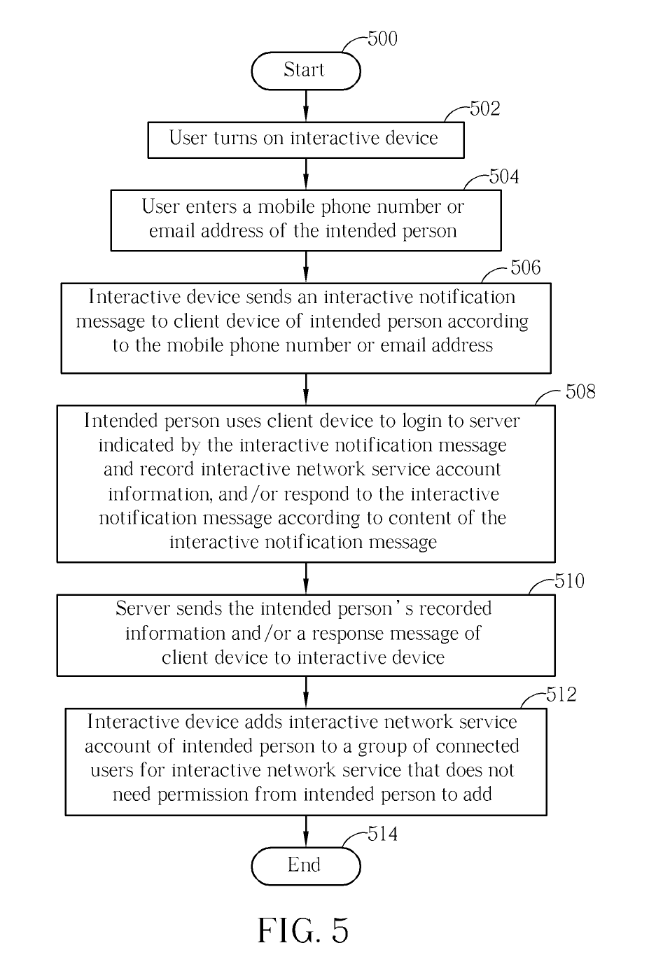

Please refer to FIG. 5, which is a flowchart of an interactive method for performing automated service configuration intuitively according to another embodiment. The method of FIG. 5 is described with reference to the interactive system 100 of FIG. 1, and includes the following steps:

Step 500: Start;

Step 502: The user turns on the interactive device 102;

Step 504: The user enters a mobile phone number or email address of the intended person;

Step 506: The interactive device 102 sends an interactive notification message to the client device 106 of the intended person according to the mobile phone number or email address;

Step 508: The intended person uses the client device 106 to login to a server 104 indicated by the interactive notification message and record interactive network service account information and/or respond to the interactive notification message according to the content of the interactive notification message;

Step 510: The server 104 sends the intended person's recorded information and/or the response message of the client device 106 to the interactive device 102;

Step 512: The interactive device 102 adds the interactive network service account of the intended person to a group of connected users for an interactive network service that does not need permission from the intended person to add;

Step 514: End.

The embodiment of FIG. 5 differs from the embodiment of FIG. 4 in that the embodiment of FIG. 5 is used for adding interactive network service accounts that do not require permission to add from the intended person, such as web blogs, online photo albums, and other such public personal websites and interactive network services. Thus, the embodiment of FIG. 5 does not require steps 412-416. Principles of operation of the rest of the embodiment shown in FIG. 5 are the same as those of the embodiment of FIG. 4.

From the above it can be seen that the embodiments provide a self-configuring, intuitive interactive system and related methods in which the user of the interactive device need only select the intended person, and the server is able to complete setup and configuration of interactive service connections between the interactive device and the client device of the intended person. Thus, the user of the interactive device need not be familiar with the knowledge and skills required to operate a computer, communications device, or web services, and also need not perform complicated setup and configuration procedures on the interactive device in order to interact with the intended person using voice, video, text, images, photos, social network contents, or even remote health services and other personalized interactive services immediately after turning on the interactive device. The interactive system also provides smart home services, as well as periodic and/or real time download of regional service content to the interactive device.

Those skilled in the art will readily observe that numerous modifications and alterations of the device and method may be made while retaining the teachings of the invention.

What is claimed is:

1. A method of performing interaction comprising:
turning on an interactive device;
inputting a mobile phone number or email address of an intended person for interacting with;
sending an interactive notification message to a server containing the mobile phone number or email address;
the server sending an interactive request message to a client device of the intended person according to the interactive notification message;
the intended person using the client device to log in to the server and record interactive network service account information and/or respond to the interactive request message according to the content of the interactive request message; and
the server sending the intended person's recorded information and/or the response message to the interactive device.

2. The method of claim 1, further comprising:
the interactive device or the server sending an add request message to an interactive network service account of the intended person; and
the intended person utilizing the client device to connect to an interactive network service account belonging to the interactive device's user with the intended person's own interactive network service account of the same corresponding interactive network service according to the add request message, and to add the user's interactive network service account to a group of connected users on the intended person's interactive network service account.

3. The method of claim 1, further comprising:
the server having sent the intended person's recorded interactive network service account information to the interactive device, the user logging in to an interactive network service account corresponding to the interactive network service recorded by the intended person to begin interaction with the intended person.

4. The method of claim 1, further comprising:
the server registering a user interactive network service account corresponding to the interactive network service on behalf of the user according to basic information of the user of the interactive device.

5. The method of claim 1, wherein the interactive request message comprises:
a web address of the server and a password used for logging into the server or response request message.

6. The method of claim 1, wherein logging into the server and/or responding to the interactive request message is logging into and recording and/or responding and recording an interactive network service account to the server and/or a web address of the interactive network service to the server corresponding to the intended person's interactive network service account.

7. A method of performing self-configuration intuitively, comprising:
turning on an interactive device;
inputting a mobile phone number or email address of an intended person for interacting with;
sending an interactive notification message to a client device of the intended person according to the mobile phone number or email address;
the intended person using the client device to log in to a server and/or respond to the interactive notification message according to the interactive notification message; and
the server sending a login and/or response complete message to the interactive device.

8. The method of claim 7, further comprising:
the interactive device or the server sending an add request message to an interactive network service account belonging to the intended person; and
the intended person utilizing the client device to connect to an interactive network service account belonging to the interactive device's user with the intended person's own interactive network service account of the same corresponding interactive network service according to the add request message, and to add the user's interactive network service account to a group of connected users on the intended person's interactive network service account.

9. The method of claim 7, further comprising:
The server having sent the intended person's recorded interactive network service account information to the interactive device, the user logging in to an interactive network service account corresponding to the interactive network service recorded by the intended person to begin interaction with the intended person.

10. The method of claim 7, further comprising:
the server registering a user interactive network service account corresponding to the interactive network service on behalf of the user according to basic information of the user of the interactive device.

11. The method of claim 7, wherein the interactive notification message comprises:
a web address of the server and a password used for logging into the server or response request message; and/or
identification information of the user and/or the user's interactive network service account.

12. The method of claim 7, wherein logging into the server and/or responding to the interactive notification message is logging into and recording and/or responding and recording an interactive network service account to the server and/or a web address of the interactive network service to the server corresponding to the intended person's interactive network service account.

13. A self-configuring, intuitive interactive system comprising:
an interactive device used for inputting a mobile phone number or email address of an intended person, and sending an interactive notification message, sending an interactive request message, sending an add request message, and adding an interactive network service account of an intended person;
a server used for receiving the interactive notification message, sending an interactive request message according to the interactive notification message on behalf of the interactive device, registering a user interactive network service account corresponding to an interactive network service, allowing an intended person to log in and record and/or respond and record an interactive network service account, and sending a login and/or response complete message to the interactive device; and
a client device used for receiving the interactive request message, connecting to the server, connecting to the interactive network service, and receiving the add request message.

14. The interactive system of claim 13, wherein the interactive device uses a touch panel, keyboard, and/or voice input interface to input the mobile phone number and/or email address and/or text messages.

15. The interactive system of claim 13, wherein the interactive device is an electronic device capable of connecting to the Internet.

16. The interactive system of claim 13, wherein registering the user interactive network service account corresponding to the interactive network service is the server registering the user interactive network service account corresponding to the interactive network service according to basic information of a user of the interactive device.
